(19) United States
(12) Patent Application Publication
(10) Pub. No.: US 2021/0213937 A1
(43) Pub. Date: Jul. 15, 2021

(54) VEHICLE CONTROL DEVICE

(71) Applicant: Hitachi Automotive Systems, Ltd., Hitachinaka-shi, Ibaraki (JP)

(72) Inventors: Masato IMAI, Tokyo (JP); Naoyuki TASHIRO, Tokyo (JP); Shinya KASAI, Tokyo (JP); Satoru OKUBO, Hitachinaka-shi (JP); Koji TAKAHASHI, Hitachinaka-shi (JP); Satoshi MATSUDA, Hitachinaka-shi (JP)

(73) Assignee: Hitachi Automotive Systems, Ltd., Hitachinaka-shi, Ibaraki (JP)

(21) Appl. No.: 15/734,466

(22) PCT Filed: Jun. 26, 2019
(86) PCT No.: PCT/JP2019/025302

§ 371 Date: Dec. 2, 2020

(30) Foreign Application Priority Data
Jul. 17, 2018 (JP) 2018-133877

(51) Int. Cl. B60W 30/06; B62D 15/02; B60W 30/09; B60W 30/10

(52) U.S. Cl. CPC B60W 30/06; B60W 30/10; B60W 30/09; B62D 15/0285

(57) ABSTRACT

To reduce a sense of discomfort to the occupants. A control device 100a includes a surrounding environment recognition unit 1 and a guidance unit 10. The surrounding environment recognition unit 1 recognizes the surrounding environment of an own vehicle 900 and sets a target parking position 901 and a travelable space of the own vehicle 900. The guidance unit 10 guides and controls the own vehicle 900 to the target parking position 901. The guidance unit 10 changes a traveling state of the own vehicle 900 according to the size of the travelable space.

### TECHNICAL FIELD

The present invention relates to a vehicle control device that automatically guides and controls a vehicle to a target parking position by automatic steering and automatic speed control.

### BACKGROUND ART

There is a technique for setting a parking path to a target parking position and automatically controlling the steering so as to move the vehicle along the parking path to park the vehicle (see PTL 1).

### CITATION LIST

### Patent Literature

PTL 1: JP 2008-296638 A

### SUMMARY OF INVENTION

### Technical Problem

For example, a parking path is generated by a combination of a process of increasing the steering angle at a constant speed (steering angle change section), a process of maintaining an increased steering angle (arc section), a process of returning the steering angle to neutral at a constant speed (steering angle change section), and a process of keeping the steering angle returned to neutral (straight section). Of the parking paths generated by the combination of such sections, the clothoid curve portion, which is the steering angle change section, has a constant rate of change in turning curvature with respect to the mileage, so the distance to reach the arc section becomes a fixed value (constant value) according to the turning curvature of the arc section. When traveling along a path where the distance to reach the arc section is a fixed value in this way, the distance of the steering angle change section is a fixed value in any situation, which causes a sense of discomfort to the occupants.

Specifically, when the steering angle change section is set short, the vehicle speed is necessarily reduced even in a wide space, which causes a sense of discomfort to the occupants with respect to the low vehicle speed. On the other hand, when the steering angle change section is set long, the small turn does not work in a narrow space, which causes a sense of discomfort to the occupants with the increase in the number of turns.

The present invention has been made in view of the above problem, and an object thereof is to provide a technology which can reduce a sense of discomfort to the occupants.

### Solution to Problem

In order to solve the above problems, a vehicle control device according to the invention includes a surrounding environment recognition unit that recognizes a surrounding environment of an own vehicle and sets a target parking position and a travelable space of the own vehicle, and a guidance unit that guides and controls the own vehicle to the target parking position. The guidance unit changes a traveling state of the own vehicle, which travels in the steering angle change section, according to a size of the travelable space.

The traveling state of the vehicle is the state of the traveling vehicle, and includes a steering angle, a vehicle speed, a steering speed, mileage, and the like of the own vehicle.

### Advantageous Effects of Invention

According to the present invention, it is possible to reduce a sense of discomfort to the occupants.

### BRIEF DESCRIPTION OF DRAWINGS

FIG. 1 is a schematic configuration diagram of a control device according to a first embodiment.

FIG. 2 is a flowchart of an automatic parking mode change process according to the first embodiment.

FIG. 3 is a flowchart of an idle process according to the first embodiment.

FIG. 4 is a flowchart of a parking space searching process according to the first embodiment.

FIG. 5 is a flowchart of an automatic parking process according to the first embodiment.

FIG. 6 is a flowchart of a turning process according to the first embodiment.

FIG. 7 is a flowchart of a stop response process according to the first embodiment.

FIG. 8 is an explanatory diagram of an example of parallel parking with a wide travelable space according to the first embodiment.

FIG. 9 is an explanatory diagram of an example of parallel parking with a narrow travelable space according to the first embodiment.

FIG. 10 is an explanatory diagram of another example of parallel parking with a narrow travelable space according to the first embodiment.

FIG. 11 is an explanatory diagram of another example of parallel parking with a narrow travelable space according to the first embodiment.

FIG. 12 is an explanatory diagram of the relationship between a passage width or various distances and an upper vehicle speed limit according to the first embodiment.

FIG. 13 is an explanatory diagram of the relationship between the passage width or various distances and the upper vehicle speed limit according to the modification.

FIG. 14 is an explanatory diagram of the relationship between a passage width or various distances and a steering speed according to another modification.

FIG. 15 is an explanatory diagram of the relationship between a passage width or various distances and a steering speed according to another modification.

### DESCRIPTION OF EMBODIMENTS

Hereinafter, embodiments will be described in detail using the drawings. Further, the embodiments described below do not limit the scope of the invention. Not all the elements and combinations thereof described in the embodiments are essential to the solution of the invention.

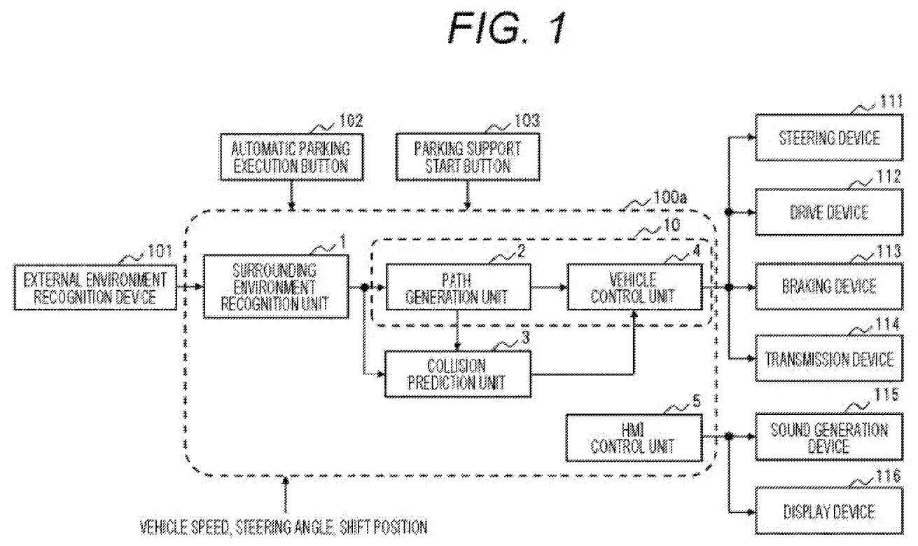

FIG. 1 is a schematic configuration diagram of a control device according to a first embodiment.

The control device 100a as an example of a “vehicle control device” illustrated in FIG. 1 is a computer that controls the own vehicle. The own vehicle includes a control device 100a, an external environment recognition device 101, a steering device 111, a drive device 112, a braking device 113, a transmission 114, a sound generation device 115, a display device 116, an automatic parking execution button 102, and a parking support start button 103.

The control device 100a executes a program stored in a storage medium (not illustrated) to function as a surrounding environment recognition unit 1, a path generation unit 2, a collision prediction unit 3, a vehicle control unit 4, and an HMI control unit 5. In particular, the path generation unit 2 and the collision prediction unit 3 function as a guidance unit 10 that guides and controls the own vehicle to a target parking position. The guidance unit 10 changes the traveling state of the own vehicle according to the size of the travelable space. The traveling state of the vehicle is the state of the traveling vehicle, and includes a steering angle, a vehicle speed, a steering speed, mileage, and the like of the own vehicle. As will be described later, the travelable space is a space in which the vehicle can be turned around in order to park in the available parking space, which is a space in which the own vehicle can be parked.

The external environment recognition device 101 is connected to the surrounding environment recognition unit 1. The steering device 111, the drive device 112, the braking device 113, and the transmission 114 are connected to the vehicle control unit 4. The sound generation device 115 and the display device 116 are connected to the HMI control unit 5. Further, the automatic parking execution button 102, the parking support start button 103, the CAN (not illustrated) of the own vehicle, and the like are connected to the control device 100a. Vehicle information of the vehicle speed, steering angle, and shift position of the own vehicle is input to the control device 100a.

The external environment recognition device 101 acquires information on the surrounding environment of the own vehicle. The external environment recognition device 101 is, for example, four in-vehicle cameras that capture the surrounding environments of the own vehicle on the front, rear, right, and left sides, respectively. The image captured by the in-vehicle camera is output as analog data or A/D converted to the surrounding environment recognition unit 1 via a dedicated line or the like.

In addition to the in-vehicle camera, the external environment recognition device 101 maybe a radar that measures the distance to an object using millimeter waves or a laser, or a sonar that measures the distance to an object using ultrasonic waves. In this case, the external environment recognition device 101 outputs information such as the distance to the obtained object and its direction to the surrounding environment recognition unit 1 via a dedicated line or the like.

The steering device 111 includes an electric or hydraulic power steering or the like capable of controlling the steering angle by an electric or hydraulic actuator or the like based on an external drive command.

The drive device 112 includes an engine system in which the engine torque can be controlled by an electric throttle or the like based on an external drive command, and an electric powertrain system in which a driving force can be controlled by a motor or the like based on an external drive command.

The braking device 113 includes an electric or hydraulic brake or the like capable of controlling the braking force by an electric or hydraulic actuator or the like based on an external braking command.

The transmission 114 includes a transmission or the like capable of switching between forward and backward movements by an electric or hydraulic actuator or the like based on an external shift command.

The sound generation device 115 is provided with a speaker or the like, and outputs an alarm or voice guidance to the driver.

The display device 116 includes a display such as a navigation device, a meter panel, and a warning light. In addition to the operation screen of the control device 100a, the display device 116 displays a warning screen or the like that visually informs the driver that the own vehicle is in danger of colliding with an obstacle.

The parking support start button 103 is an operating member provided at a position where the driver can operate the parking support start button 103.

The parking support start button 103 outputs a start signal for starting the operation of the control device 100a to the control device 100a based on the operation of the driver. When the control device 100a is starting, the parking support start button 103 may output an end signal for ending the operation of the control device 100a to the control device 100a based on the operation of the driver.

The automatic parking execution button 102 is an operating member provided at a position where the driver can operate the automatic parking execution button 102.

The automatic parking execution button 102 outputs a start signal for starting the operation of the control device 100a to the control device 100a based on the operation of the driver.

The parking support start button 103 and the automatic parking execution button 102 may be installed as switches in a place around the steering wheel that is easy for the driver to operate. Further, the parking support start button 103 and the automatic parking execution button 102 may be operated by the driver by displaying the buttons on the display device 116 when the display device 116 is a touch panel type display.

Based on the image data of the surroundings of the own vehicle input from the external environment recognition device 101, the surrounding environment recognition unit 1 detects the shapes and positions of stationary solid objects, moving bodies, road surface painting such as parking borders, and signs around the own vehicle. Further, the surrounding environment recognition unit 1 has a function of detecting unevenness of the road surface and determining whether the own vehicle can drive on the road surface. The stationary solid object is, for example, a parked vehicle, a wall, a pole, a pylon, a curb, a bollard, or the like. Further, the moving body is, for example, a pedestrian, a bicycle, a motorcycle, a vehicle, or the like. In the following description, the stationary solid object and the moving body are collectively referred to as an obstacle. The shape and position of the object is detected by pattern matching techniques or other known techniques. The position of an object is expressed using, for example, a coordinate system whose origin is the position of an in-vehicle camera that photographs the front of the own vehicle.

Further, the surrounding environment recognition unit 1 sets the available parking space, the travelable space, and the like based on the information on the shape and position of the detected object and the determination result of whether the own vehicle is on a travelable road surface. For example, in the case of a parking lot, the available parking space is a space in which the own vehicle can be parked, and the available parking space includes a target parking position for parking the own vehicle. The available parking space is a space where the vehicle can be turned around in order to park in the travelable space. The travelable space is defined based on the passage width, the distance to the obstacle in front of the own vehicle, the position of the obstacle (parked vehicle) adjacent to the available parking space, and the like.

The path generation unit 2 generates a parking path for moving the own vehicle from the current position of the own vehicle to the target parking position. For example, in the case of a parking lot, the path generation unit 2 sets the target parking position of the own vehicle in the available parking space based on the current position of the own vehicle and the positional relationship with the obstacle, and generates a parking path. That is, the path generation unit 2 changes the parking path according to the size of the travelable space. The parking path may include at least forward and backward movements.

The parking path is generated by a combination of a process of increasing the steering angle at a constant speed (steering angle change section), a process of maintaining the increased steering angle (arc section), a process of returning the steering angle to neutral at a constant speed (steering angle change section), and a process of keeping the steering angle returned to neutral (straight section). The steering angle change section is a section before the transition to the arc section or the straight section, and is a section in which the steering angle changes at a constant speed.

The collision prediction unit 3 determines whether the own vehicle collides with an obstacle when the own vehicle travels along the parking path generated by the path generation unit 2. Specifically, the collision prediction unit 3 estimates a movement path of the moving body based on the recognition result of the surrounding environment recognition unit 1, and determines whether the own vehicle collides with a moving body at the intersection between the parking path of the own vehicle and the prediction path of the moving body.

The vehicle control unit 4 controls the own vehicle along the parking path generated by the path generation unit 2. The vehicle control unit 4 calculates a target steering angle and a target speed based on the parking path. Then, the vehicle control unit 4 outputs a target steering torque for realizing the target steering angle to the steering device 111. Further, the vehicle control unit 4 outputs a target engine torque and a target braking pressure for realizing the target speed to the drive device 112 and the braking device 113. Further, when the collision prediction unit 3 predicts a collision between the own vehicle and an obstacle, the vehicle control unit 4 calculates a target steering angle and a target speed so that the own vehicle does not collide with the obstacle. Then, the vehicle control unit 4 outputs control parameters based on the calculated target steering angle and target speed to the steering device 111, the drive device 112, and the braking device 113. Further, the vehicle control unit 4 determines that the own vehicle has reached a turning position for switching between forward and backward movements, and outputs the shift command to the transmission 114 when it is necessary to change the advancing direction.

The HMI control unit 5 appropriately generates information for notifying the driver and the occupants according to the situation, and outputs the information to the sound generation device 115 and the display device 116.

Next, the processing procedure of the control device 100a will be described using a flowchart.

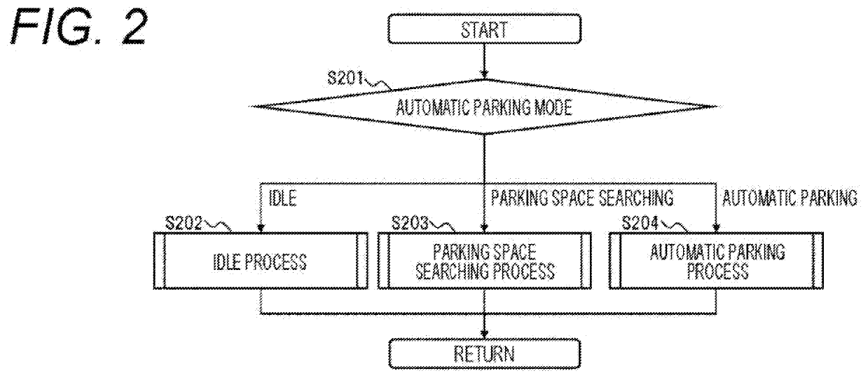

FIG. 2 is a flowchart of an automatic parking mode change process according to the first embodiment.

In S201 of FIG. 2, the process is changed based on the current automatic parking mode. That is, the control device 100a determines whether the current automatic parking mode is an idle mode, a parking space searching mode, or an automatic parking mode. The control device 100a proceeds to the idle process of S202 when the automatic parking mode is idle, proceeds to S203 in the parking space searching mode, and proceeds to S204 in the automatic parking mode.

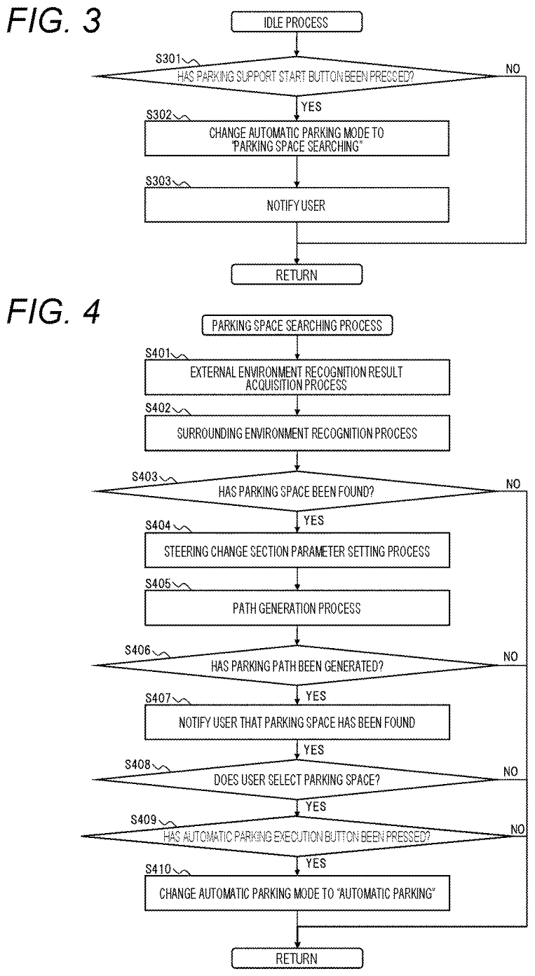

FIG. 3 is a flowchart of the idle process according to the first embodiment.

In S301 of FIG. 3, the control device 100a determines whether the parking support start button 103 has been pressed. The control device 100a proceeds to S302 when the determination result of S301 is positive, and ends the process when the determination result of S301 is negative.

In S302, the control device 100a changes the automatic parking mode to the parking space searching mode, and proceeds to S303. The control device 100a notifies the user that the automatic parking mode has changed, and ends the process (S303).

FIG. 4 is a flowchart of the parking space searching process according to the first embodiment.

In S401 of FIG. 4, the surrounding environment recognition unit 1 starts taking in image data from the external environment recognition device 101. The captured image data is input to the surrounding environment recognition unit 1.

In S402, based on the image data captured by S401, the surrounding environment recognition unit 1 detects the shapes and positions of stationary solid objects around the own vehicle, a moving body, road surface painting such as parking borders, and objects such as signs. Further, the surrounding environment recognition unit 1 detects, for example, the target parking position, the available parking space, the travelable space, and the like in the case of parking lot based on the information on the shape and position of the detected object and the determination result of whether the own vehicle is on a travelable road surface.

In S403, the path generation unit 2 determines whether an available parking space has been found. The path generation unit 2 proceeds to S404 when the determination result of S403 is positive, and ends the process when the determination result of S403 is negative.

In S404, the path generation unit 2 sets a parameter (for example, a distance) as an example of the “traveling state” in the steering angle change section used in the next path generation process of S405 according to the size of the travelable space.

In S405, the path generation unit 2 generates a parking path that the own vehicle can reach from the current position in the available parking space detected in S403. In S406, the path generation unit 2 determines whether the parking path can be generated. If the determination result of S406 is positive, the process proceeds to S407, and if the determination result of S403 is negative, the process ends.

In S407, the path generation unit 2 notifies the user that the available parking space has been found. The path generation unit 2 determines whether the user has selected an available parking space (S408).

If the determination result of S408 is positive, the path generation unit 2 proceeds to S409 and determines whether the automatic parking execution button has been pressed (S409). If the determination result of S409 is positive, the path generation unit 2 proceeds to S410, changes the automatic parking mode to the automatic parking mode, and ends the process (S410). On the other hand, the path generation unit 2 ends the process when the determination result of S408 is negative and when the determination result of process S409 is negative.

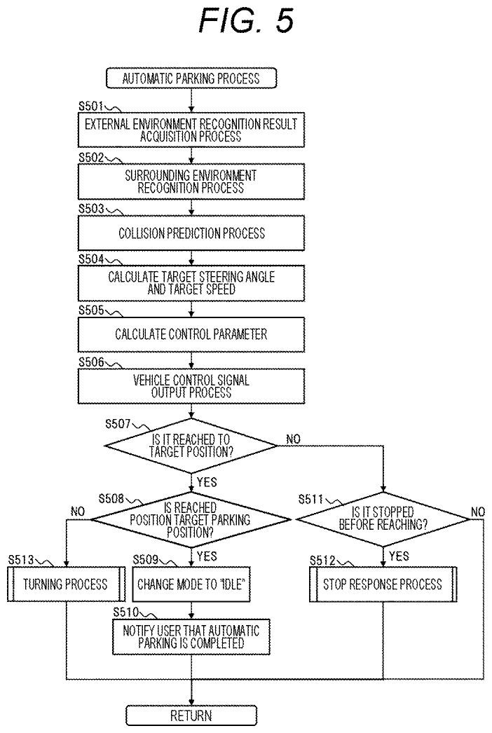

FIG. 5 is a flowchart of the automatic parking process according to the first embodiment.

In S501 and S502 of FIG. 5, the surrounding environment recognition unit 1 executes the same process as S401 and S402 of FIG. 4.

In S503, the collision prediction unit 3 determines whether the own vehicle collides with an obstacle when the own vehicle moves along the parking path calculated in S405.

In S504, the vehicle control unit 4 calculates the target steering angle and the target speed of the own vehicle based on the parking path generated in S405 and the collision prediction result for the obstacle determined in S503.

In S505, the vehicle control unit 4 calculates control parameters for outputting the target steering angle and target speed calculated in S504 to the steering device 111, the drive device 112, and the braking device 113, respectively. For example, as a control parameter output to the steering device 111, a target steering torque for achieving a target steering angle can be mentioned. However, the target steering angle may be output directly depending on the configuration of the steering device 111. Further, the control parameters output to the drive device 112 and the braking device 113 include a target engine torque and a target braking pressure for realizing the target speed. However, the target speed may be output directly depending on the configuration of the drive device 112 and the braking device 113.

In S506, the vehicle control unit 4 outputs the calculated control parameters as vehicle control signals to the steering device 111, the drive device 112, and the braking device 113, respectively, so as to guide and control the own vehicle up to the target parking position along the parking path. In S507, the vehicle control unit 4 determines whether the own vehicle has reached the target parking position. If the determination result of S507 is positive, the process proceeds to S508, and if the determination result of S507 is negative, the process proceeds to S511.

In S508, the vehicle control unit 4 determines whether the reached position is the target parking position.

If the determination result of S508 is positive, the process proceeds to S509, the vehicle control unit 4 changes the automatic parking mode to the idle mode (S509), notifies the user of that fact (S510), and ends the process. On the other hand, if the determination result of S508 is negative, the process is terminated after proceeding to the turning process described later in S513.

In S511, the vehicle control unit 4 determines whether the own vehicle has stopped before reaching the target parking position. If the determination result of S511 is positive, the process proceeds to S512 and ends. On the other hand, if the determination result of S511 is negative, the process ends as it is.

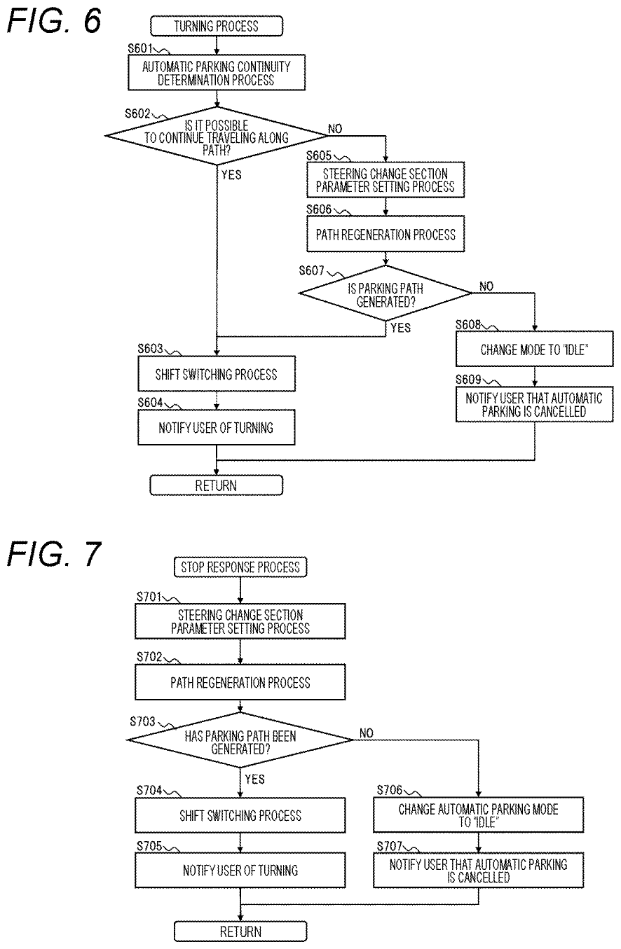

FIG. 6 is a flowchart of the turning process according to the first embodiment.

The turning process is the details of the process of S513 when the target position is not the target parking position in S508 of FIG. 5 (the determination result of S508 is negative), that is, when the target position is the turning position.

In S601, the path generation unit 2 determines whether the vehicle can continue traveling along the parking path calculated in S405 at the stopped turning position. Here, the path generation unit 2 compares the target parking position extracted by S402 at the start of parking with the target parking position extracted by S502 when the turning position is reached. Then, the path generation unit 2 determines that, for example, when the distance between the two is a predetermined value (for example, 10 cm) or more, the vehicle cannot travel along the parking path calculated by S405.

In S602, the path generation unit 2 determines whether the determination result in S601 can continue traveling along the parking path. If the determination result of S602 is positive, the process proceeds to S603, and the path generation unit 2 outputs a command value to the transmission 114 to switch the shift position (S603), notifies the user of the turning back (S604), and the process ends. On the other hand, the path generation unit 2 proceeds to S605 when the determination result of S602 is negative.

In S605, the path generation unit 2 sets a parameter as an example of the “traveling state” in the steering angle change section used in the next S606. In S606, the path generation unit 2 regenerates the parking path.

In S607, the path generation unit 2 determines whether the parking path can be generated. If the determination result of S607 is positive, the process proceeds to S603, and if the determination result of S607 is negative, the process proceeds to S608. The path generation unit 2 changes the automatic parking mode to the idle mode (S608), notifies the user that the automatic parking is stopped (S609), and ends the process.

As a result, it is possible to continue the guidance control of the own vehicle while ensuring the safety of the own vehicle when moving backward.

In S604 and S609, when the vehicle guidance control is continued or stopped, the HMI control unit 5 may execute the continuation or cancellation of the vehicle guidance control when the operation from the user is received via the HMI or the like.

FIG. 7 is a flowchart of the stop response process according to the first embodiment.

The stop response process is the details of the process of S512 when the vehicle is stopped before reaching the target position in S511 (the determination result of S511 is positive).

In S701, the path generation unit 2 sets a parameter as an example of the “traveling state” in the steering angle change section used in the next S702, and regenerates the parking path in S702. As a result, the guidance control of the own vehicle can be continued while ensuring the safety.

In S703, the path generation unit 2 determines whether the parking path can be generated. If the determination result of S703 is positive, the process proceeds to S704. The path generation unit 2 outputs a command value to the transmission 114 in order to switch the shift position (S704), notifies the user of the turning back (S705), and ends the process. On the other hand, if the determination result of S703 is negative, the process proceeds to S706. The path generation unit 2 changes the automatic parking mode to the idle mode (S706), notifies the user that the automatic parking is stopped (S707), and ends the process. As a result, safety can be prioritized.

In S705 and S707, when the vehicle guidance control is continued or stopped, the HMI control unit 5 may execute the continuation or cancellation of the vehicle guidance control after receiving the operation from the user via the HMI or the like.

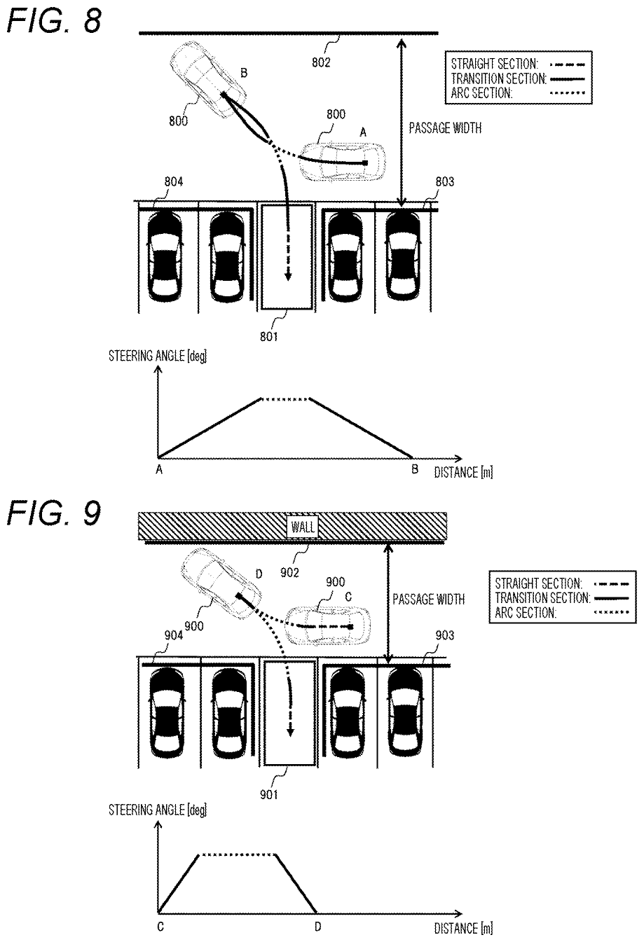

Next, a setting example and a setting method of the steering angle change section will be described with reference to FIG. 8.

FIG. 8 is an explanatory diagram of parallel parking with a wide travelable space. Specifically, this is an example in which the own vehicle 800 starts automatic parking from point A, passes through the turning position of point B, and reaches the target parking position 801.

In this example, a plurality of parked vehicles are parked side by side on the left and right sides of the target parking position 801.

Therefore, the boundary with these parked vehicles becomes a boundary 803 and a boundary 804 with the parked vehicle as an example of the “obstacle on the front side of the target parking position”. The travelable space in this example is the region inside the boundaries 803 and 804 with the parked vehicle, and the passage boundary 802 (in the case of sufficiently wide passage, the passage width is set to 7 m) as an example of the virtually installed “obstacles facing the target parking position across the passage”.

The surrounding environment recognition unit 1 sets the available parking space and the travelable space based on the boundaries 803 and 804 and the passage boundary 802. In this example, the passage width is relatively wide and the travelable space is relatively wide. In this case, the vehicle control unit 4 sets a large upper limit speed, which is a parameter as an example of the “traveling state” set in the steering angle change section, and the path generation unit 2 sets the steering angle change section relatively long. That is, the vehicle control unit 4 changes the vehicle speed and steering angle of the own vehicle up to the target parking position 801 according to the size of the travelable space, and the path generation unit 2 changes the steering angle of the own vehicle up to the target parking position 801.

At this time, the parking path from point A to the turning position of point B is generated by a combination of a steering angle change section that increases the steering angle clockwise, an arc section that holds the increased steering angle, and a steering angle change section that returns the steering angle to neutral. The parking path from point B to the target parking position 801 is generated by a combination of a steering angle change section that increases the steering angle counterclockwise, an arc section that holds the increased steering angle, a steering angle change section that returns the steering angle to neutral, and a process of maintaining the neutral steering angle (straight section).

As a result, when the travelable space is relatively wide, it is possible to calculate the parking path when the vehicle speed of the own vehicle is high, so that it is possible to reduce a sense of discomfort to the occupants.

FIG. 9 is an explanatory diagram of an example of parallel parking in which the travelable space is narrow. Specifically, this is an example in which the own vehicle 900 starts automatic parking from point C, passes through the turning position of point D, and reaches the target parking position 901.

The travelable space in this example is the region inside the boundaries 903 and 904 with the parked vehicles and a passage boundary 902 as an example of “an obstacle facing the target parking position across the passage”.

The surrounding environment recognition unit 1 sets the available parking space and the travelable space based on the boundaries 903 and 904 and the passage boundary 902. In this example, the passage width is narrow and the travelable space is narrow compared with those in the example of FIG. 8. In this case, the vehicle control unit 4 sets a small upper limit speed, which is a parameter as an example of the “traveling state” set in the steering angle change section, and the path generation unit 2 sets the steering angle change section relatively short.

At this time, the parking path from point C to the turning position of point D is generated by a combination of a process of maintaining the neutral steering angle (straight section), a steering angle change section that increases the steering angle clockwise, an arc section, and a steering angle change section that returns the steering angle to neutral. The parking path from the turning position of point D to the target parking position 901 is generated by a combination of a steering angle change section that increases the steering angle counterclockwise, an arc section, a steering angle change section that returns the steering angle to neutral, and a process of maintaining the neutral steering angle (straight section).

By setting in this way, when the travelable space is relatively narrow, it is possible to generate a compact parking path in which the speed of the own vehicle is low and the number of times of turning back is small, so that a sense of discomfort to the occupants can be reduced.

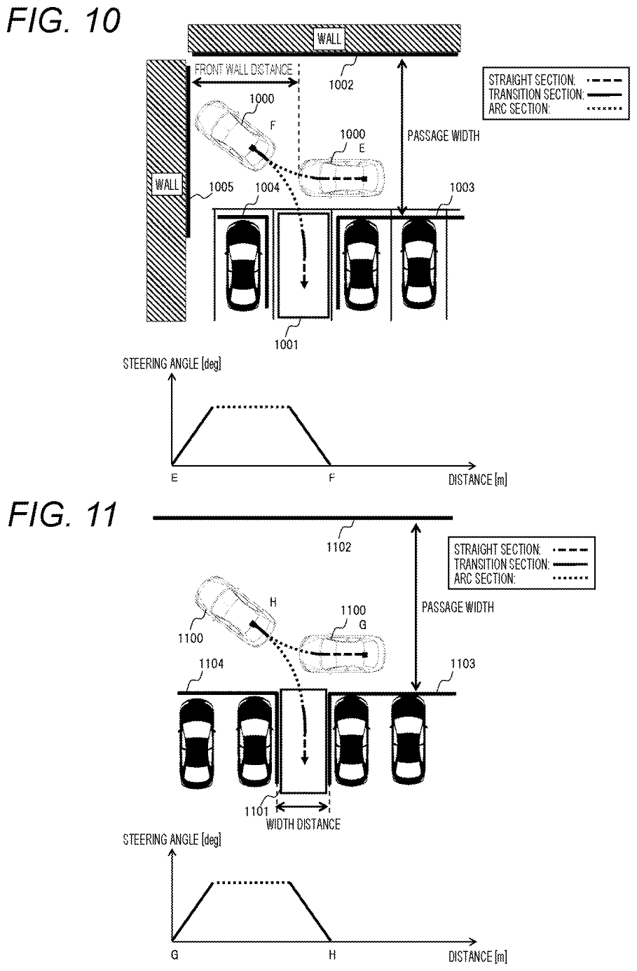

FIG. 10 is an explanatory diagram of another example of parallel parking in which the travelable space is narrow. Specifically, this is an example in which the own vehicle 1000 starts automatic parking from point E, passes through the turning position of point F, and reaches the target parking position 1001.

The travelable space in this example is the region inside the boundaries 1003 and 1004 with the parked vehicle, a passage boundary 1002 as an example of “an obstacle facing the target parking position across the passage”, and a boundary 1005 as an example of “an obstacle on the side opposite to the own vehicle with the target parking position interposed” with respect to the front wall.

The surrounding environment recognition unit 1 sets the available parking space and the travelable space based on the boundaries 1003 and 1004, the passage boundary 1002, and the boundary 1005. Compared with the example of FIG. 9, the passage width is wide and the distance to the front wall is short. Therefore, the vehicle control unit 4 determines that the travelable space is narrow, and sets the upper limit speed set in the steering angle change section to be small. The path generation unit 2 sets the steering angle change section to be short.

By setting in this way, when the travelable space is relatively narrow, it is possible to generate a compact parking path in which the speed of the own vehicle is low and the number of times of turning back is small, so that a sense of discomfort to the occupants can be reduced.

FIG. 11 is an explanatory diagram of another example of parallel parking in which the travelable space is narrow. Specifically, this is an example in which the own vehicle 1100 starts automatic parking from point G, passes through the turning position of point H, and reaches the target parking position 1101.

The travelable space in this example is the region inside the boundaries 1103 and 1104 with the parked vehicle, and the passage boundary 1102 (in the case of sufficiently wide passage, the passage width is set to 7 m) as an example of the virtually installed “obstacles facing the target parking position across the passage”.

The surrounding environment recognition unit 1 sets the available parking space and the travelable space based on the boundary 1103 and the boundary 1104 and the passage boundary 1102. Compared with the example of FIG. 8, the passage width does not change and the width distance (width of the target parking position 1101) is narrow. Therefore, the vehicle control unit 4 determines that the travelable space is narrow, and sets the upper limit speed, which is a parameter set in the steering angle change section, to be small. The path generation unit 2 sets the steering angle change section to be short.

By setting in this way, when the travelable space is relatively narrow, it is possible to generate a compact parking path in which the speed of the own vehicle is low and the number of times of turning back is small, so that a sense of discomfort to the occupants can be reduced.

In the example of FIG. 11, when moving forward from point G to the turning position of point H, the upper limit speed may be increased and the steering angle change section may be set longer. Only when moving backward from point H to the target parking position 1101, the upper limit speed may be reduced to shorten the steering angle change section.

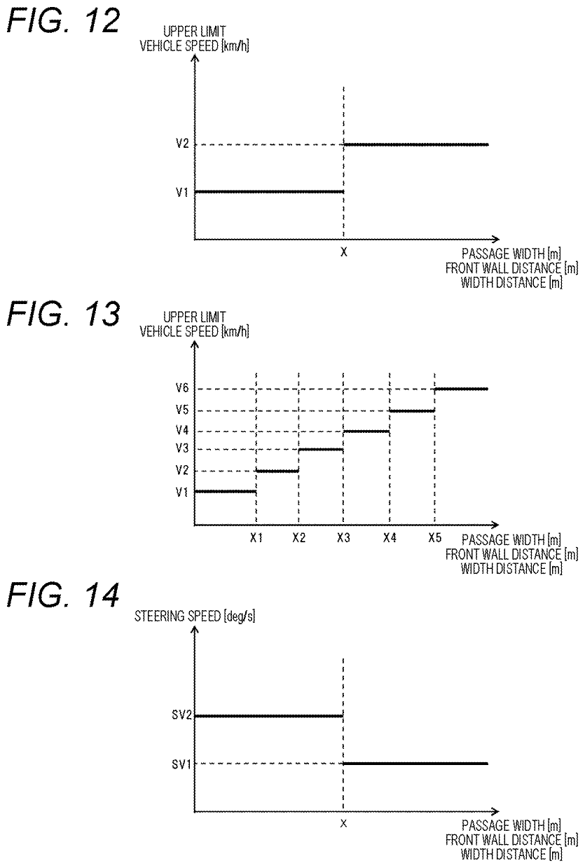

FIGS. 12 and 13 are explanatory diagrams of the relationship between the passage width or various distances and the upper vehicle speed limit. Specifically, the relationship among the passage width, the front wall distance, and the width distance described in FIGS. 8 to 11 and the upper limit speed is illustrated.

FIG. 12 illustrates a method in which one threshold value is set for each of the passage width, the front wall distance, and the width distance, and the upper limit speed is switched at the threshold value. That is, the vehicle control unit 4 sets the own vehicle to a first vehicle speed V1 when any of the passage width, the front wall distance, and the width distance is equal to or more than a predetermined value, and when the passage width is less than the predetermined value, the vehicle control unit 4 sets the own vehicle to a first vehicle speed V2 (V2>V1). For example, the passage width is set to X=5.5 m, the front wall distance to X=4 m, and the width distance to X=3 m. As a result, it is possible to improve safety while reducing a sense of discomfort to the occupants.

Further, FIG. 13 is an explanatory diagram of the relationship between the passage width or various distances and the upper vehicle speed limit according to a modification. In this example, a plurality of threshold values are set for each of the passage width, the front wall distance, and the width distance, and the upper limit speed is gradually switched at the threshold values. That is, the vehicle control unit 4 may set the vehicle speed of the own vehicle to be smaller as the passage width is narrower or any one of the front wall distance and the width distance is smaller. For example, a total of six threshold values, V1 to V6, may be set.

Next, a case where the parameter as an example of the “traveling state” set in the steering angle change section is the steering speed will be described.

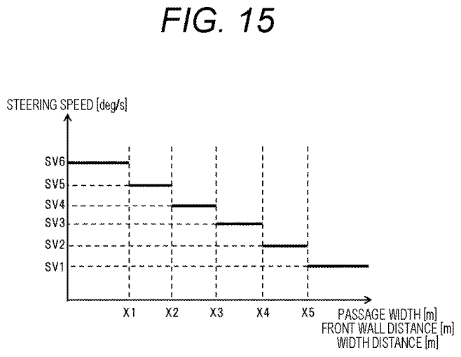

FIGS. 14 and 15 are explanatory diagrams of the relationship between the passage width or various distances and the steering speed according to another modification. Specifically, the relationship among the passage width, the front wall distance, the width distance, and the steering speed is illustrated.

As can be seen in comparison with FIG. 12, when the passage width, the front wall distance, and the width distance are each narrow, the steering speed is increased and the steering angle change section is set short.

However, if the steering speed is changed, the rotation speed of the steering is also changed, which may give the occupant a sense of discomfort. Therefore, it is desirable to change the distance of the steering angle change section by changing the upper limit speed.

As described above, by changing the parameters (upper limit speed, steering speed) set in the steering angle change section based on the travelable space, it is possible to generate the parking path, which does not cause the occupant to feel uncomfortable, according to the size of the travelable space.

In this embodiment, normal parallel parking has been taken as an example. However, it can also be applied when parking the own vehicle in a garage such as home. Further, it can be applied to parallel parking and diagonal parking instead of parallel parking.

As described above, it can be carried out in various ways without departing from the spirit of the invention.

For example, the path generation unit 2 may set the steering angle change section longer as the travelable space is wider and the vehicle speed or steering speed of the own vehicle is higher. As a result, the steering angle of the own vehicle can be changed gently, and a sense of discomfort to the occupants can be reduced.

For example, when the operation by the occupant of the own vehicle is accepted, the vehicle control unit 4 may restart or stop the guidance control of the own vehicle. As a result, the operation of the occupant can be reflected.

The travelable space may include a space on the parking path side of the own vehicle and may not include a space on the opposite side of the parking path with respect to the own vehicle.

For example, the following expressions can be expressed based on the embodiments described so far.

<Expression> A vehicle control method in which a surrounding environment of an own vehicle is recognized to set a target parking position of the own vehicle and the travelable space (S402, S502), a traveling distance of the steering angle change section is set according to the size of the travelable space while the own vehicle changes the steering angle (S404), a parking path to which the own vehicle can reach from the current position is generated (S405), a target steering angle and a target speed of the own vehicle are calculated based on the parking path (S504), and the own vehicle is guided and controlled to the target parking position along the parking path (S506).

### REFERENCE SIGNS LIST

1 surrounding environment recognition unit
2 path generation unit
4 vehicle control unit
10 guidance unit
100a control device
800 own vehicle
801 target parking position, E own vehicle
901 target parking position
1000 own vehicle
1001 target parking position
1100 own vehicle
1101 target parking position

1. A vehicle control device, comprising:
a surrounding environment recognition unit that recognizes a surrounding environment of an own vehicle and sets a target parking position and a travelable space of the own vehicle; and
a guidance unit that guides and controls the own vehicle to the target parking position,
wherein the guidance unit changes a traveling state of the own vehicle according to a size of the travelable space.

2. The vehicle control device according to claim 1, wherein the traveling state includes a vehicle speed of the own vehicle up to the target parking position.

3. The vehicle control device according to claim 1, wherein the traveling state includes a steering angle of the own vehicle up to the target parking position.

4. The vehicle control device according to claim 1, wherein the traveling state includes a steering speed of the own vehicle up to the target parking position.

5. The vehicle control device according to claim 1, wherein a parking path to the target parking position includes a steering angle change section in which the own vehicle travels while changing a steering angle, and
the traveling state includes a distance of the steering angle change section.

6. The vehicle control device according to claim 1, wherein
the surrounding environment recognition unit sets the travelable space based on at least one of
an obstacle on a front side of the target parking position,
an obstacle facing the target parking position across a passage, and
an obstacle on a side opposite to the own vehicle with the target parking position interposed.

7. The vehicle control device according to claim 5, wherein
the guidance unit has a path generation unit that generates the parking path including at least forward and backward movements, and
the path generation unit sets the steering angle change section shorter as the travelable space is narrower.

8. The vehicle control device according to claim 7, wherein the path generation unit sets the steering angle change section longer as a vehicle speed or a steering speed of the own vehicle increases.

9. The vehicle control device according to claim 7, wherein
the guidance unit includes a vehicle control unit that guides and controls the own vehicle along the parking path, and
the vehicle control unit sets the own vehicle to be at a first speed when the passage width is equal to or greater than a predetermined value, and sets the own vehicle to be at a second speed smaller than the first speed when the passage width is less than a predetermined value.

10. The vehicle control device according to claim 7, wherein
the guidance unit includes a vehicle control unit that guides and controls the own vehicle along the parking path, and
the vehicle control unit sets the vehicle speed of the own vehicle to be smaller as the passage width is narrower.

11. The vehicle control device according to claim 9, wherein
when the own vehicle is stopped during the guidance control,
the path generation unit regenerates the parking path, and
the vehicle control unit restarts the guidance control of the own vehicle.

12. The vehicle control device according to claim 11, wherein
when the path generation unit cannot regenerate the parking path at the stop position,
the vehicle control unit stops the guidance control of the own vehicle.

13. The vehicle control device according to claim 9, wherein
when it is determined that the own vehicle cannot be guided and controlled along the parking path when the own vehicle reaches a turning position for switching between forward and backward movements,
the path generation unit regenerates the parking path, and
the vehicle control unit restarts the guidance control of the own vehicle.

14. The vehicle control device according to claim 13, wherein
when the path generation unit cannot regenerate the parking path at the turning position,
the vehicle control unit stops the guidance control of the own vehicle.

15. The vehicle control device according to claim 11, wherein
when an operation by an occupant of the own vehicle is accepted,
the vehicle control unit restarts or stops the guidance control of the own vehicle.
